(19) United States
(12) Patent Application Publication
(10) Pub. No.: US 2002/0123022 A1
(43) Pub. Date: Sep. 5, 2002

(54) System of securement of dental abutments to dental implants

(76) Inventors: Nicola Pilla, Rome (IT); Patricio Nilo, Pembroke Pines, FL (US); Bruce L. Hollander, Boca Raton, FL (US); Gilbert Ohana, Plantation, FL (US)

Correspondence Address: Melvin K. Silverman, MELVIN K. SILVERMAN & ASSOC., P.C., SUITE 440, 4901 NORTH FEDERAL HIGHWAY, FORT LAUDERDALE, FL, 33308, US

(21) Appl. No.: 10/127,159

(22) Filed: Apr. 22, 2002

Related U.S. Application Data
(63) Continuation-in-part of application No. 09/429,106, filed on Oct. 28, 1999, now abandoned.

(51) Int. Cl. A61C 8/00

(52) U.S. Cl. 433/173; 433/172

(57) ABSTRACT

A system for tooth implantation having an implant part to be set into the jawbone, and an abutment part to which a tooth restoration is attached. The abutment part is screwed onto the implant part by an abutment screw, and a locking screw is disposed to lock the abutment screw to secure the abument part to the implant part to prevent loosening of the abutment. The threading interface between the lock screw and an abutment channel is matched in spiral direction but mismatched in thread timing with an interface between said abutment screw and an implant channel, thereby generating radial and axial locking forces.

### REFERENCE TO RELATED APPLICATION

This case is a continuation-in-part of application Ser. No. 09/429,106, filed Oct. 28, 1999.

(c), (d)

N/A

### (e) BACKGROUND OF THE INVENTION

A longstanding problem in the area of implant dentistry has been that of effecting reliable securement of the abutment of a dental restoration to an implant which has been embedded within the jaw of a patient.

In the prior art, securement of an abutment to its implant has typically been effected through the use of a screw to screw thread channel connection from the abutment to the implant, that is, through the use of a torquable screw head of an Allen Head type having a shank threaded into a complementally threaded co-axial channel within the dental implant. This technique, which is as old as implant dentistry itself, has suffered from vulnerability to loosening by reason of the accumulated effect, over time, of microscopic rotation and counter-torquing of the abutment relative to the implant. Therein, it has been found that even a microscopic separation between opposing surfaces of an abutment and implant can create a void space sufficient for the growth and development of bacteria, the effect of which can be gum disease as well as eventual further loosing of the abutment-implant interface. Such loosing of the prosthesis can cause discomfort to the patient.

The prior art, as known to the within inventors, is reflected in U.S. Pat. No. 5,169,308 (1992) to Kvist, entitled Device for Tooth Implantation; and U.S. Pat. No. 5,733,122 (1998) to Gordon, entitled Dental Implant Attachment Assembly Including Device and Method for Resisting, Loosening of Attachment. More particularly, said Kvist teaches the use of a locking screw to secure an abutment to implant securement screw, however, using a locking screw having a direction of spiral (handedness) which is opposite to the direction of spiral of the abutment securement screw and its interface with the threadings of the axial channel of the abutment. It has been found that the method and device of Kvist is often counter productive to the objective of locking the abutment screw into place, due to the fact that, in tightening or torquing of the lock screw after it is in distal contact with the top of the abutment screw, friction across this interface will occur in an angular direction which actually operates to dislodge the abutment securement screw, that is, resulting in the exact opposite of the desired objective.

With respect to said patent to Gordon, while both the locking screw and the abutment securement screw are threaded in the same direction, the only interface between the distal end of the lock screw and the proximal end face of the abutment screw comprises an annular ring having a width of approximately 1.25 millimeters. Therefore, as a practical matter, the tortional forces, to which an abutment is subjected during normal use of a restoration by a patient, are such that the narrow annular interface of the locking screw to abutment screw of Gordon will provide very little assistance in maintaining the head of the abutment screw in a stable position relative to the bottom shoulder or seat of the abutment channel and relative to the implant itself.

The instant invention thereby seeks to improve upon state-of-the-art of lock screws for securement of dental abutments to dental implants.

### (h) SUMMARY OF THE INVENTION

In a system of securing a dental abutment to a dental implant, the implant having proximal and distal radial end surfaces symmetric about an axis of said system, the implant includes an axial channel at least partially threaded, directed distally into said implant from said proximal end surface, in which a threading of said implant channel defines a first spiral direction and a first thread timing thereof. Said system particularly comprises an abutment having proximal and distal radial end surfaces, and an axial abutment channel co-axial with said system axis, extending between said radial end surfaces, said abutment channel at least partially threaded and proportioned for receipt of a head of an abutment screw at an annular shoulder at a base thereof, to secure said abutment to said implant, in which said distal radial end surface of said abutment is complemental to said proximal end surface of said implant, said head of said abutment screw including a torquable axial channel directed into said proximal end surface thereof, said screw including a distally projecting at least partially threaded, integral member, complemental in radius, threading and spiral direction to a said first spiral direction and thread timing of said axial channel of said implant. The system further includes a lock screw, complemental in radius to said abutment channel, having proximal and distal radial end surfaces thereof, including a torquable axial channel upon said system axis within said proximal radial end surface, said lock screw defining a surface of rotation about said radius having threadings thereupon complemental to said abutment channel and of like spiral direction to said threadings of said abutment screw, but having a second and different thread timing than said abutment screw and complemental channel of the implant. Said difference in timing between (i) said threading of complemental surfaces of said abutment channel and said lock screw and (ii) said threading of said complemental abutment screw and implant channel, generates outward radial forces at the lock screw to abutment channel threading interface and downward axial forces between said distal radial end surface of said lock screw and said proximal radial end surface of said abutment screw, when said torquable channel of said lock screw is torqued.

It is accordingly an object of the present invention to provide an improved means of securing a dental abutment to its corresponding dental implant.

It is another object to provide a means of securement between an abutment and an implant, which will assure long-term stability of the abutment and its associated dental restoration, relative to the implant and, thereby, increased comfort to the patient.

It is a further object to provide a system of the above type, which will minimize the potential for the development of microscopic bacteria-containing crevices between the abutment and implant.

It is thereby a yet further object of the invention to provide a system of securement of dental abutments of the above type that will reduce the possibility of gum disease resultant from long term weakening of the implant-abutment interface.

The above and yet other objects and advantages of the present invention will become apparent from the hereinafter set forth Brief Description of the Drawings, Detailed Description of the Invention and Claims appended herewith.

### (g) BRIEF DESCRIPTION OF THE DRAWINGS

FIG. 1 is an exploded view showing the components of the inventive system.

FIG. 2 is an axial cross-sectional assembly view thereof.

FIG. 3 is an enlarged view of circle 3-3 in FIG. 2.

### (h) DETAILED DESCRIPTION OF THE INVENTION

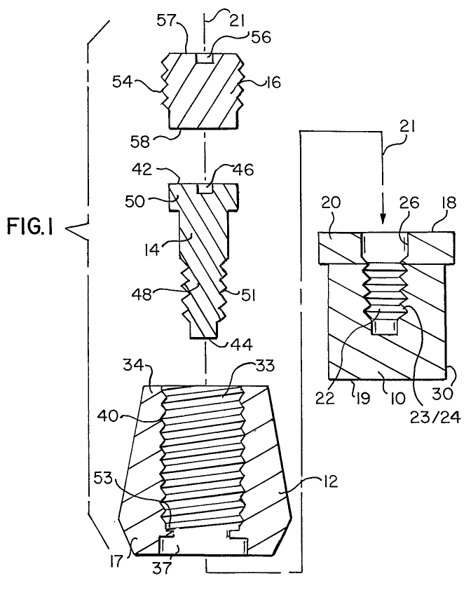

With reference to the exploded view of FIG. 1, the components of the instant system for securement of dental abutments may be seen to include a dental implant 10, a dental abutment 12, an abutment securement screw 14, and a locking screw 16. A tapered surface 17 is termed the cuff of the abutment, a distal surface of which also comprises a distal surface 36 of said abutment.

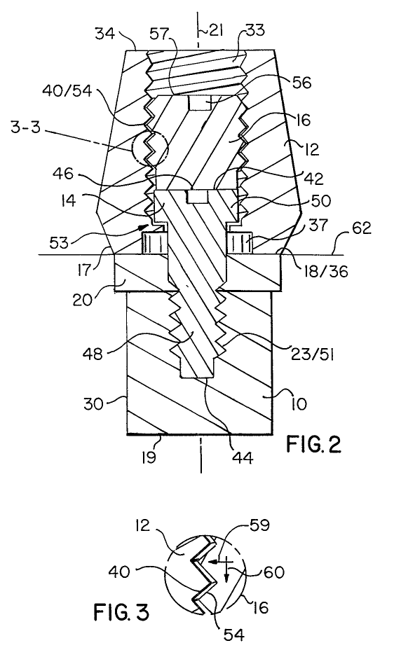

As may be further noted with reference to FIGS. 1 and 2, the dental implant 10 includes a proximal end surface 18, distal end surface 19 and a collar 20, all of which surfaces are radially symmetric about a system axis 21, which is also an axis of rotation of both the implant 10 and the abutment 12. Said implant includes an axial channel 22 having a threaded portion 24 and an unthreaded portion 26. It is, thereby, to be appreciated that axially directed channel 22 must be at least partially threaded. It is further noted that threadings 23 of threaded portion 24 of implant channel 22 are characterized by a first thread-timing (also known as screw rate parameter or thread separation), that is, a parameter definable in terms of rate of angular rotation of the circumference of a screw turned within such channel. This parameter may be established either by screw channel radius or axial thread density.

Lateral surfaces 30 of the implant 10 may be threaded or otherwise treated to maximize bio-integration of the implant into bone 32 of the jaw of a patient. See FIG. 2.

The dental abutment 12 includes proximal and distal end surfaces 34 and 36 respectively, which are radially symmetric about the system axis 21. The abutment 12 is if further characterized by an axial abutment channel 33 (often termed the chimney of the abutment), which communicates between said proximal and distal surfaces 34 and 36 respectively of the abutment. See FIG. 1. It is noted that abutment channel 33 must be at least partially threaded and, further, threadings 40 thereof define a second thread-timing parameter, that is, a parameter of screw rate which differs from said first timing parameter of threadings 23 of axial channel 22 of the implant 10, but which exhibits the same spiral direction as that of said threadings 23 of implant channel 22.

Upon assembly of the abutment into the implant, the proximal end surface 18 of the implant 10 is complemental to said distal end surface 36 of the abutment 12, and defines a fit of less than five microns.

With regard to abutment securement screw 14, the same may be seen to include proximal and distal end surfaces 42 and 44 respectively. Abutment securement screw 14 further includes a head 50 having torquable axial channel 46 which enables it to be threadly advanced into implant channel 22 along a distally projecting integral member 48 of the screw until said head 50 thereof contacts and compresses against a shoulder 53 at a base of said abutment channel 33. Integral projecting member 48 of the abutment screw is, of course, dimensionally complemental to axial channel 22 of implant 10 and, as well, as to its threadings 23. Accordingly, threadings 51 of member 48 will exhibit the same timing parameter as threadings 23 of axial channel 22 of implant 10. See FIG. 2.

Further shown in the figures is said lock screw 16, which includes proximal and distal radial end surfaces 57 and 58 respectively. Therein, threadings 54 upon a lateral surface of lock screw 16 are complemental with threadings 40 of axial abutment channel 33. The timing (but not the direction of spiral) of these threadings 40/54 must, as above noted, differ from that of complemental threadings 23 of implant 10 and threading 51 of the projecting member 48 of abutment screw 14. Lock screw 16 further includes a torquable axial channel 56 within a proximal end surface 57, which may be tightened, by the use of an Allan Head or dental analog wrench, into flush contact with proximal surface 42 of abutment securing screw 14.

With reference to FIG. 2 and the enlarged view of FIG. 3, it is to be understood that, after abutment screw 14 is fully tightened within implant channel 22, lock screw 16 in then advanced and tightened against proximal radial surface 42 of abutment screw 14. Due to the mismatch of thread timings at said thread interface 23/51 in the implant channel 22, relative to thread interface 40/54 in the abutment channel 23, lock screw threads 54 are microscopically forced out of registration with threadings 40 of the abutment channel 33 to produce a locking effect at said interface 40/54. Accordingly, any application of torque upon lock screw 16, after screw 14 it is fully set upon shoulder 53 of channel 33, and radial end surfaces 58 and 42 of the respective screws 16 and 14 are in contact, will cause a locking effect of the second timing parameter of said interface 40/54 relative to the first timing parameter of said interface 23/51 within the implant. That is, said mismatch of timings will generate outward radial forces 59 and downward axial forces 60 at said interface 40/54 at the walls of abutment channel 33. See FIG. 3. These downward forces are transmitted to abutment channel shoulder 53 and to the implant-abutment interface 18/36. The result of this action is an effective lock between abutment 12 and implant 10 such that, across radial surfaces 18/36, which occurs essentially at gum line 62 of bone 32, a stable long-term, that is, non-rotational securement between the implant and abutment is assured, this having numerous advantages to the patient as is more fully set forth in the Background of the Invention above.

It is noted that, to achieve sufficient difference in thread-timing parameters, the ratio of the radius of said abutment channel 33 to said implant channel 22 should preferably be in range of about 3:1 to about 1:1. If thread density is used as the operative timing parameter, such density would fall in a range of 1 to 20 threads per axial centimeter, in which said channels must therefore have a difference in thread density of at least 2 threads per centimeter. Further, the ratio of axial length of the abutment screw 14 to the lock screw 16 is in a range of about 1:1 to about 4:1. Also, the timing parameter 23/51 of said abutment screw 14 is established relative to said greater or lesser thread-timing parameter 40/54 of said lock screw 16 by a ratio of implant to abutment channel radius in a range of about 10:1 to about 1:10. Further, the threaded portion 24 of the implant channel 22 comprises at least 50 percent of the entire axial length thereof.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith

We claim

1. A system of securing a dental abutment to a dental implant, the implant having proximal and distal radial end surfaces symmetric about an axis of said system, the implant including an axial channel at least partially threaded, directed distally into said implant from said proximal end surface, in which a threading of said implant channel defines a first spiral direction and a first thread timing thereof, said system comprising:
(a) an abutment having proximal and distal radial end surfaces, and an axial abutment channel co-axial with said system axis, extending between said radial end surfaces, said abutment channel at least partially threaded and proportioned for receipt of a head of an abutment screw at an annular shoulder at a base thereof, to secure said abutment to said implant, in which said distal radial end surface of said abutment is complemental to said proximal end surface of said implant, said head of said abutment screw including a torquable axial channel directed into said proximal end surface thereof, said screw including a distally projecting at least partially threaded, integral member, complemental in radius, threading and spiral direction to a said first spiral direction and thread timing of said axial channel of said implant; and
(b) a lock screw, complemental in radius to said abutment channel, having proximal and distal radial end surfaces thereof, including a torquable axial channel upon said system axis within said proximal radial end surface, said lock screw defining a surface of rotation about said radius having threadings thereupon complemental to said abutment channel and of like spiral direction to said threadings of said abutment screw, but having a second and different thread timing, than said abutment screw and complemental channel of said implant
whereby said difference in timing between (i) said threading of complemental surfaces of said abutment channel and said lock screw and (ii) said threading of said complemental abutment screw and implant channel, generates outward radial forces at the abutment channel to lock screw threading interface and downward axial forces between said distal radial end surface of said lock screw and said proximal radial end surface of said abutment screw, when said torquable channel of said lock screw is torqued.

2. The system as recited in claim 1, in which said abutment channel comprises a different radius that said radius of said implant channel.

3. The system as recited in claim 1, in which said torquing channel of said abutment screw is entirely covered when said lock screw is secured within said abutment channel.

4. The system as recited in claim 1, in which said thread timing parameter of said abutment screw comprises a range of between 1 and 20 threads per axial centimeter; and in which that of said greater or lesser thread-timing parameter of said lock screw comprises a range of between 1 and 20 threads per axial centimeter

5. The system as recited as recited in claim 2, in which a ratio of axial length of said abutment screw to said lock screw is in a range of about 1:1 to about 4:1.

6. The system as recited in claim 2, in which a threaded portion of said axial implant channel comprises at least fifty percent of the entire axial length thereof.

7. The system as recited in claim 1, in which said timing parameter of said abutment screw is established relative to said greater or lesser thread-timing parameter of said lock screw by a ratio of implant to abutment channel radius in a range of about 10:1 to about 1:10.

8. The system as recited in claim 4, in which a ratio of axial length of said abutment screw to said lock screw comprises a range of about 10:1 to about 4:1.

9. The system as recited in claim 4, in which a threaded portion of said axial implant channel comprises at least fifty percent of said axial length thereof.

10. The system as recited in claim 6, in which a threaded portion of said projecting member of said abutment screw comprises at least fifty percent of said axial length thereof.

11. The system as recited in claim 3, in which said timing parameter of said abutment screw is established relative to said greater or lesser thread-timing parameter of said lock screw by a ratio of implant to abutment channel radius in a range of about 10:1 to about 1:10.

12. The system as recited in claim 4, in which said timing parameter of said abutment is established relative to said greater or lesser thread-timing parameter of said lock screw by a ratio of implant to abutment channel radius in a range of about 10:1 to about 1:10.

13. The system as recited in claim 8, in which said timing parameter of said abutment screw is established relative to said greater or lesser thread-timing parameter of said lock screw by a ratio of implant to abutment channel radius in a range of about 10:1 to about 1:10.
